(19) United States
(12) Patent Application Publication
(10) Pub. No.: US 2013/0318996 A1
(43) Pub. Date: Dec. 5, 2013

(54) COOLING ASSEMBLY FOR A BUCKET OF A TURBINE SYSTEM AND METHOD OF COOLING

(71) Applicant: Stephen Paul Wassynger, Simpsonville, SC (US)

(72) Inventor: Stephen Paul Wassynger, Simpsonville, SC (US)

(73) Assignee: GENERAL ELECTRIC COMPANY, Schenectady, NY (US)

(21) Appl. No.: 13/486,700

(22) Filed: Jun. 1, 2012

(51) Int. Cl. F02C 7/18; F02C 6/08

(52) U.S. Cl. 60/782; 416/97 R; 60/806; 60/785

(57) ABSTRACT

A cooling assembly for a bucket of a turbine system includes a shroud assembly operably coupled to an outer casing of a turbine section. Also included is an airfoil having at least one cavity, wherein the at least one cavity is configured to receive a cooling flow from a cooling source through at least one channel disposed within the shroud assembly.

### BACKGROUND OF THE INVENTION

The subject matter disclosed herein relates to turbine systems, and more particularly to a cooling assembly for a bucket of such turbine systems, as well as a method of cooling the bucket.

In turbine systems, such as gas turbine systems, a combustor converts the chemical energy of a fuel or an air-fuel mixture into thermal energy. The thermal energy is conveyed by a fluid, often compressed air from a compressor, to a turbine where the thermal energy is converted to mechanical energy. As part of the conversion process, hot gas is flowed over and through portions of the turbine as a hot gas path. High temperatures along the hot gas path can heat turbine components, causing degradation of components.

One such component requiring cooling is a bucket that is directly subjected to the hot gas path during operation of the turbine system. Various cooling schemes have been employed in attempts to effectively and efficiently cool the bucket. Often, cooling is achieved by injecting a cooling flow into a cavity of the bucket from a radially inner root region that also must include relatively large metal portions for supporting high stress loads imposed on the bucket at outer tip portions of the bucket, particularly for large, last-stage buckets of a turbine section. Competing space between the air supply at the root and supporting metal portions pose issues with aerodynamic design of the turbine section.

### BRIEF DESCRIPTION OF THE INVENTION

According to one aspect of the invention, a cooling assembly for a bucket of a turbine system includes a shroud assembly operably coupled to an outer casing of a turbine section. Also included is an airfoil having at least one cavity, wherein the at least one cavity is configured to receive a cooling flow from a cooling source through at least one channel disposed within the shroud assembly.

According to another aspect of the invention, a cooling assembly for a bucket of a turbine system includes a rotating airfoil having a leading edge and a trailing edge and at least one cavity therebetween. Also included is at least one seal rail disposed proximate an outer tip of the rotating airfoil. Further included is a shroud assembly operably coupled to an outer casing of a turbine section, wherein the shroud assembly includes at least one recess configured to receive the at least one seal rail in close proximity thereto, thereby forming a pressurized plenum proximate an outer region of the at least one cavity for receiving a cooling flow from a cooling source, wherein the cooling flow is transferred to the pressurized plenum through at least one channel within the shroud assembly.

According to yet another aspect of the invention, a method of cooling a bucket of a turbine system is provided. The method includes disposing at least one outer tip of an airfoil proximate a shroud assembly located radially outwardly thereof, wherein the airfoil comprises at least one cavity. Also included is pressurizing a plenum located proximate an outer region of the at least one cavity and relatively adjacent at least one outlet of at least one channel disposed within the shroud assembly. Further included is injecting a cooling flow into the plenum through the at least one channel.

These and other advantages and features will become more apparent from the following description taken in conjunction with the drawings.

### BRIEF DESCRIPTION OF THE DRAWING

The subject matter, which is regarded as the invention, is particularly pointed out and distinctly claimed in the claims at the conclusion of the specification. The foregoing and other features and advantages of the invention are apparent from the following detailed description taken in conjunction with the accompanying drawings in which:

FIG. 1 is a schematic illustration of a turbine system;

FIG. 2 is a cross-sectional view of a first embodiment of a bucket within a turbine section of the turbine system having a radially aligned cooling flow supply;

FIG. 3 is a cross-sectional view of a second embodiment of the bucket;

FIG. 4 is a cross-sectional view of the bucket having an axially aligned cooling flow supply; and

FIG. 5 is a flow diagram illustrating a method of cooling the bucket.

The detailed description explains embodiments of the invention, together with advantages and features, by way of example with reference to the drawings.

### DETAILED DESCRIPTION OF THE INVENTION

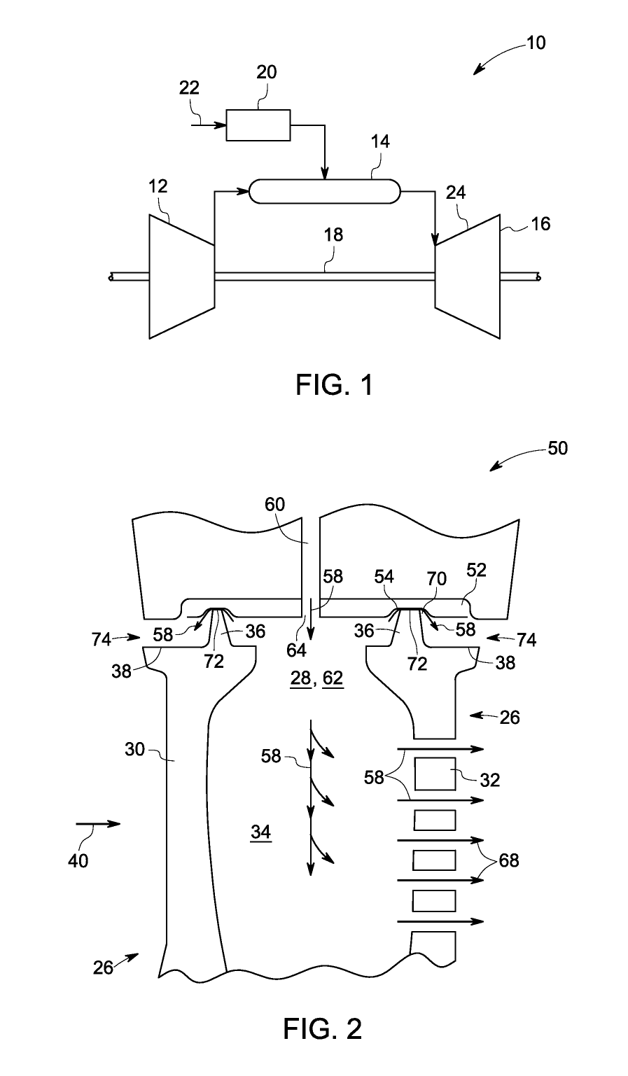

Referring to FIG. 1, a gas turbine system is schematically illustrated with reference numeral 10. The gas turbine system 10 includes a compressor section 12, a combustor section 14, a turbine section 16, a shaft 18 and a fuel nozzle 20. It is to be appreciated that one embodiment of the gas turbine system 10 may include a plurality of compressors 12, combustors 14, turbines 16, shafts 18 and fuel nozzles 20. The compressor section 12 and the turbine section 16 are coupled by the shaft 18. The shaft 18 may be a single shaft or a plurality of shaft segments coupled together to form the shaft 18.

The combustor section 14 uses a combustible liquid and/or gas fuel, such as natural gas or a hydrogen rich synthetic gas, to run the gas turbine system 10. For example, fuel nozzles 20 are in fluid communication with an air supply and a fuel supply 22. The fuel nozzles 20 create an air-fuel mixture, and discharge the air-fuel mixture into the combustor section 14, thereby causing a combustion that creates a hot pressurized exhaust gas. The combustor section 14 directs the hot pressurized gas through a transition piece into a turbine nozzle (or “stage one nozzle”), and other stages of buckets and nozzles causing rotation of turbine blades within an outer casing 24 of the turbine section 16. Rotation of the turbine blades causes the shaft 18 to rotate, thereby compressing the air as it flows into the compressor section 12. In an embodiment, hot gas path components are located in the turbine section 16, where hot gas flow across the components causes creep, oxidation, wear and thermal fatigue of turbine components. Examples of hot gas components include bucket assemblies (also known as blades or blade assemblies), nozzle assemblies (also known as vanes or vane assemblies), shroud assemblies, transition pieces, retaining rings, and compressor exhaust components. The listed components are merely illustrative and are not intended to be an exhaustive list of exemplary components subjected to hot gas. Controlling the temperature of the hot gas components can reduce distress modes in the components.

Referring now to FIG. 2, a cross-sectional view of a first embodiment of a bucket, which may be referred to interchangeably with an airfoil 26, is partially illustrated. Specifically, a radially outer region of the airfoil 26 is shown. As noted above, the airfoil 26 is configured to rotate within the outer casing 24 of the turbine section 16 about the shaft 18. The airfoil 26 includes a leading edge 30 and a trailing edge 32 that converge together (not illustrated) to form at least one cavity 34 therebetween. At least one seal rail 36 is disposed along a tip portion 38 of at least one of the leading edge 30 and the trailing edge 32, wherein the tip portion 38 is located at a radially extreme position along the airfoil 26. As illustrated, the at least one seal rail 36 will typically be disposed along the tip portion 38 of both the leading edge 30 and the trailing edge 32 and extends generally radially outwardly from the tip portion 38. The at least one seal rail 36 reduces leakage of a working fluid passing through the turbine section 16 along a main flow path 40 and may be constructed of the same material as the airfoil 26 or any other suitable material. The at least one seal rail 36 may be integrally formed with the airfoil 26 or operably coupled to the airfoil 26, where one or more components may be disposed between the at least one seal rail 36 and the tip portion 38 of the airfoil 26.

The tip portion 38 of the airfoil 26, and more specifically the at least one seal rail 36, is disposed in close proximity to a shroud assembly 50 located radially outwardly of the tip portion 38. The shroud assembly 50 is stationary and operably coupled to the outer casing 24 of the turbine section 16. Along a radially inner portion 52 of the shroud assembly 50 is at least one recess 54 for closely receiving the at least one seal rail 36. The at least one recess 54 may be pre-fabricated within the shroud assembly 50 or may form during operation of the gas turbine system 10. Specifically, in the case of formation of the at least one recess 54 during operation of the gas turbine system 10, rotation of the airfoil 26 causes the at least one seal rail 36 to interact with a material located at the radially inner portion 52 of the shroud assembly 50 that is configured to easily wear away upon contact with the at least one seal rail 36 during rotation of the airfoil 26. Such an arrangement may be referred to as a “honeycomb” structure that conforms to the at least one seal rail 36 to ensure a close fitting relationship between the at least one seal rail 36 and the shroud assembly 50.

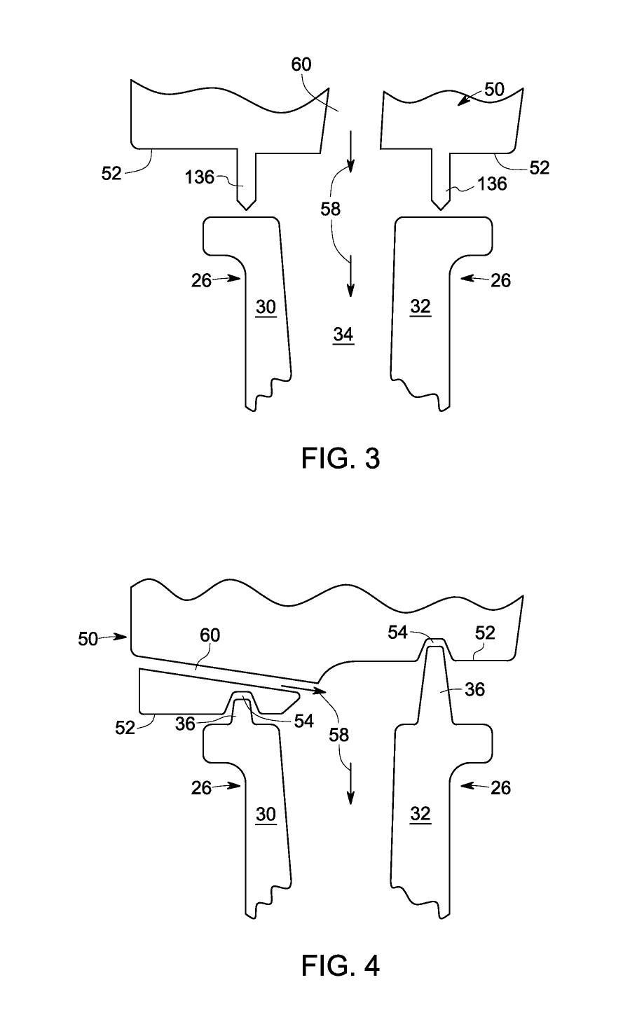

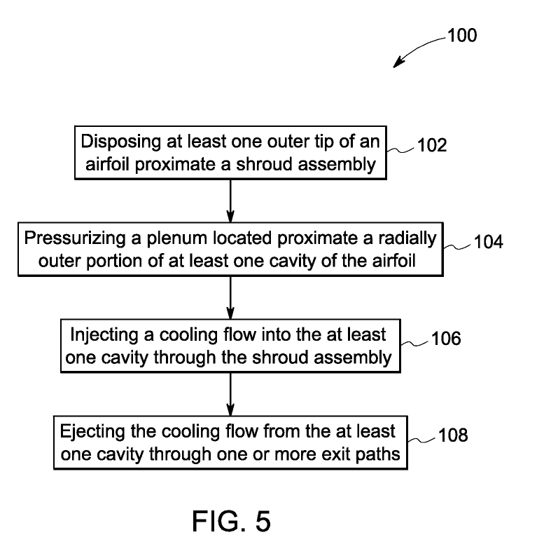

Referring now to FIG. 3, a second embodiment of the airfoil 26 is contemplated that includes at least one seal rail 136 protruding radially inwardly from the inner portion 52 of the shroud assembly 50, rather than radially outwardly from the tip portion 38 of the airfoil 26. The at least one seal rail 136 provides sealing between the airfoil 26 and the shroud assembly 50. The at least one seal rail 136 may be operably coupled to, or integrally formed with the shroud assembly 50. Other structural elements described in conjunction with FIG. 2 may be included in the second embodiment.

As discussed above, certain components within the turbine section 16 require cooling due to thermal conditions that the components are subjected to during operation of the gas turbine system 10. The airfoil 26 generally, and more particularly the tip portion 38 of the airfoil 26, are components that require cooling. One such cooling scheme includes injecting a cooling flow 58 into the at least one cavity 34 through at least one channel 60 located within the shroud assembly 50. The cooling flow 58 is supplied by a cooling source, which may comprise numerous sources, with one exemplary cooling source comprising pressurized air supplied by the compressor section 12 and routed to the shroud assembly 50. The at least one channel 60 within the shroud assembly 50 directs the cooling flow 58 into a plenum 62 disposed at a radially outer region 28 of the at least one cavity 34. The plenum 62 is formed, at least in part, by the leading edge 30, the trailing edge 32 and the at least one seal rail 36. The cooling flow 58 thereby enters the at least one cavity 34, and more specifically, the plenum 62 through an outlet 64 of the at least one channel 60 for providing a cooling effect upon the airfoil 26. It is to be appreciated that the outlet 64 of the at least one channel 60 may be oriented at numerous angles within the shroud assembly 50, including in a substantially radial alignment, as shown in FIG. 2, or alternatively in a substantially axial alignment (FIG. 4), as well as in a circumferential arrangement to provide a circumferential velocity component for the incoming flow for more efficient use of the cooling flow. Furthermore, in order for the cooling flow 58 to escape the at least one cavity 34, at least one, but typically a plurality of exit holes 68 are disposed within the trailing edge 32 and extend from the at least one cavity 34 through the trailing edge 32. It is also contemplated that the plurality of exit holes 68 may be disposed in various other regions, such as the leading edge 30, for example. Irrespective of the precise location of the plurality of exit holes 68, the plurality of exit holes 68 provide paths for the cooling flow 58 to exit the at least one cavity 34 into the main flow path 40.

An additional path of escape for the cooling flow 58 is provided by a gap 70 between an outer edge 72 of the at least one seal rail 36 and the at least one recess 54. The at least one seal rail 36 separates the at least one cavity 34, and more specifically the plenum 62, from an exterior tip region 74. The gap 70 allows the cooling flow 58 to exit the at least one cavity 34 and to be expelled proximate the exterior tip region 74. In addition to such a path through the gap 70 providing a route of escape for the cooling flow 58, the cooling flow 58 provides a cooling effect on the exterior tip portion 74, which is at a first pressure. To facilitate exit of the cooling flow 58 through the plurality of exit holes 68 and/or the gap 70, the at least one cavity 34, and more particularly the plenum 62, is pressurized to a second pressure that is greater than the first pressure. This ensures the cooling flow 58 moving toward the lower pressure regions, specifically the exterior tip region 74.

As illustrated in the flow diagram of FIG. 3, and with reference to FIGS. 1 and 2, a method of cooling 100 a bucket of a turbine system is also provided. The airfoil 26 and the shroud assembly 50 have been previously described and specific structural components need not be described in further detail. The method of cooling 100 includes disposing at least one outer tip of the airfoil proximate the shroud assembly 102, and more specifically proximate the at least one recess 54, as discussed above. The plenum is pressurized 104 to a pressure greater than that of exterior regions, such as the exterior tip region 74, for example. The cooling flow is injected 106 into the at least one cavity 34 through the at least one channel 60 of the shroud assembly 50, from which the cooling flow is ejected 108 through one or more exit paths, such as the plurality of exit holes 68 and/or the gap 70, as discussed above.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A cooling assembly for a bucket of a turbine system comprising:
a shroud assembly operably coupled to an outer casing of a turbine section; and
an airfoil having at least one cavity, wherein the at least one cavity is configured to receive a cooling flow from a cooling source through at least one channel disposed within the shroud assembly.

2. The cooling assembly of claim 1, further comprising at least one seal rail extending radially outwardly from a tip portion of the airfoil, wherein the shroud assembly includes at least one recess configured to receive the at least one seal rail in close proximity thereto.

3. The cooling assembly of claim 1, further comprising a plenum formed proximate an outer region of the at least one cavity by at least one seal rail and the shroud assembly.

4. The cooling assembly of claim 3, further comprising an exterior region proximate a tip portion of the airfoil, wherein the exterior region is separated from the plenum by the at least one seal rail and is at a first pressure, wherein the plenum is pressurized at a second pressure, wherein the second pressure is greater than the first pressure.

5. The cooling assembly of claim 4, further comprising a gap disposed between an outer edge of the at least one seal rail and the shroud assembly, wherein the cooling flow passes through the gap to the exterior region for cooling the tip portion.

6. The cooling assembly of claim 1, further comprising at least one seal rail extending radially inwardly from an inner portion of the shroud assembly.

7. The cooling assembly of claim 1, further comprising:
a leading edge and a trailing edge defining the at least one cavity therebetween; and
at least one exit hole extending from the at least one cavity through the airfoil for allowing the cooling flow within the at least one cavity to exit to a main flow path of the turbine section.

8. The cooling assembly of claim 1, wherein the at least one channel disposed within the shroud assembly is oriented axially and comprises an outlet proximate a plenum for injecting the cooling flow into the plenum.

9. The cooling assembly of claim 1, wherein the at least one channel disposed within the shroud assembly is oriented radially and comprises an outlet proximate a plenum for injecting the cooling flow into the plenum.

10. The cooling assembly of claim 1, wherein the cooling source comprises a compressor of the turbine system.

11. A cooling assembly for a bucket of a turbine system comprising:
a rotating airfoil having a leading edge and a trailing edge and at least one cavity therebetween;
at least one seal rail disposed proximate an outer tip of the rotating airfoil; and
a shroud assembly operably coupled to an outer casing of a turbine section, wherein the shroud assembly includes at least one recess configured to receive the at least one seal rail in close proximity thereto, thereby forming a pressurized plenum proximate an outer region of the at least one cavity for receiving a cooling flow from a cooling source, wherein the cooling flow is transferred to the pressurized plenum through at least one channel within the shroud assembly.

12. The cooling assembly of claim 11, further comprising an exterior region proximate a tip portion of the rotating airfoil, wherein the exterior region is separated from the pressurized plenum by the at least one seal rail.

13. The cooling assembly of claim 12, wherein the exterior region is at a first pressure, wherein the pressurized plenum is at a second pressure, wherein the second pressure is greater than the first pressure.

14. The cooling assembly of claim 13, further comprising a gap disposed between an outer edge of the at least one seal rail and the shroud assembly, wherein the cooling flow passes through the gap to the exterior region for cooling the tip portion.

15. The cooling assembly of claim 11, further comprising at least one exit hole extending from the at least one cavity through the rotating airfoil for allowing the cooling flow within the at least one cavity to exit to a main flow path of the turbine section.

16. The cooling assembly of claim 11, wherein the at least one channel disposed within the shroud assembly is oriented radially and comprises an outlet proximate the plenum for injecting the cooling flow into the pressurized plenum.

17. A method of cooling a bucket of a turbine system comprising:
disposing at least one outer tip of an airfoil proximate a shroud assembly located radially outwardly thereof, wherein the airfoil comprises at least one cavity;
pressurizing a plenum located proximate an outer region of the at least one cavity and relatively adjacent at least one outlet of at least one channel disposed within the shroud assembly; and
injecting a cooling flow into the plenum through the at least one channel.

18. The method of claim 17, further comprising passing the cooling flow over a seal rail to an exterior tip portion of the airfoil for cooling the exterior tip portion.

19. The method of claim 17, further comprising ejecting the cooling flow from the at least one cavity through at least one exit hole disposed within the airfoil.

20. The method of claim 17, supplying the cooling flow with compressed air from a compressor section of the turbine system.
